(19) United States
(12) Patent Application Publication
(10) Pub. No.: US 2016/0110181 A1
(43) Pub. Date: Apr. 21, 2016

(54) METHOD AND DEVICE FOR UPGRADING A ROUTER

(71) Applicant: Xiaomi Inc., Beijing (CN)

(72) Inventors: Jialin FAN, Beijing (CN); Yongfeng XIA, Beijing (CN); Tiejun LIU, Beijing (CN)

(73) Assignee: Xiaomi Inc.

(21) Appl. No.: 14/851,735

(22) Filed: Sep. 11, 2015

Related U.S. Application Data
(63) Continuation of application No. PCT/CN2015/074877, filed on Mar. 23, 2015.

(30) Foreign Application Priority Data
Oct. 16, 2014 (CN) 201410550394.8

(51) Int. Cl. G06F 9/445; H04L 29/06; H04L 29/08

(52) U.S. Cl. CPC G06F 8/65; H04L 67/06; H04L 67/42; H04L 67/10

(57) ABSTRACT

A method for upgrading a first router apparatus of at least two router apparatuses communicating with a terminal and a server includes detecting whether an application in the first router apparatus needs to be upgraded and, if the application needs to be upgraded, acquiring an upgrade file from the server through a communication link between a second router apparatus of the at least two router apparatuses and the server. The method further includes sending the upgrade file to the first router apparatus.

### CROSS REFERENCE TO RELATED APPLICATIONS

The present application is a continuation of International Application No. PCT/CN2015/074877, filed Mar. 23, 2015, which is based upon and claims priority to Chinese Patent Application No. 201410550394.8 filed on Oct. 16, 2014, the entire contents of both of which are incorporated herein by reference.

### TECHNICAL FIELD

The present disclosure relates to computer technology and, more particularly, to a method, device, and apparatus for upgrading a router.

### BACKGROUND

A portable router, such as a wireless router, usually has a built-in SIM (Subscriber Identity Module) card, and can establish a data link, such as a GPRS (General Packet Radio Service) link or a GSM (Global System for Mobile Communication) link, with the Ethernet via the SIM card, and can also connect to a terminal through a wireless network. Therefore, the portable router can provide data service to the terminal, and the terminal can connect to the Internet via the router.

A portable router usually needs an operation system to function properly. From time to time, the equipment manufacturer may introduce a new version of the operation system having new functions. Therefore, the operation system of the portable router often needs to be upgraded to optimize the portable router.

In the conventional technology, when a portable router needs to upgrade a current version of operation system to a new version of operation system, the portable router first needs to download an upgrade package from a server using the data link with the Ethernet, and then upgrades the current version of operation system to the new version of operation system using the upgrade package.

### SUMMARY

In accordance with the present disclosure, there is provided a method for upgrading a first router apparatus of at least two router apparatuses communicating with a terminal and a server. The method includes detecting whether an application in the first router apparatus needs to be upgraded and, if the application needs to be upgraded, acquiring an upgrade file from the server through a communication link between a second router apparatus of the at least two router apparatuses and the server. The method further includes sending the upgrade file to the first router apparatus.

Also in accordance with the present disclosure, there is provided a device for upgrading a first router apparatus of at least two apparatuses communicating with the device and a server. The device includes a processor and a non-transitory computer-readable storage medium storing instructions. The instructions, when executed by the processor, cause the processor to detect whether an application in the first router apparatus needs to be upgraded and, if the application needs to be upgraded, acquire an upgrade file from the server through a communication link between a second router apparatus of the at least two router apparatuses and the server. The instructions further cause the processor to send the upgrade file to the first router apparatus.

Also in accordance with the present disclosure, there is provided a non-transitory computer-readable storage medium storing instructions for upgrading a first router apparatus of at least two router apparatuses communicating with a terminal and a server. The instructions, when executed by one or more processors of the terminal, causes the terminal to detect whether an application in the first router apparatus needs to be upgraded and, if the application needs to be upgraded, acquire an upgrade file from the server through a communication link between a second router apparatus of the at least two router apparatuses and the server. The instructions further cause the terminal to send the upgrade file to the first router apparatus.

It should be understood that both the above general description and the following detailed description are illustrative and explanatory, which do not limit the present disclosure.

### BRIEF DESCRIPTION OF THE DRAWINGS

The accompanying drawings, which are incorporated into and constitute a part of this specification, illustrate embodiments being consistent with the disclosure and, together with the description, serve to explain the principles of the disclosure.

FIG. 1 is a diagram illustrating a system according to an exemplary embodiment.

FIG. 2 is a flowchart showing a method for upgrading according to another exemplary embodiment.

FIG. 3 is a flowchart showing a method for upgrading according to another exemplary embodiment.

FIG. 4 is a flowchart showing a method for upgrading according to another exemplary embodiment.

FIG. 5 is a flowchart showing a method for upgrading according to another exemplary embodiment.

FIG. 6 is a diagram illustrating a scene according to an exemplary embodiment.

FIG. 7 is a block diagram illustrating a device for upgrading according to an exemplary embodiment.

FIG. 8 is a block diagram illustrating an apparatus for upgrading according to an exemplary embodiment.

### DETAILED DESCRIPTION

Exemplary embodiments will be described in detail herein, with examples thereof shown in drawings. In the following descriptions, when the drawings are referred to, unless otherwise specified, the same number in different drawings refers to the same or similar elements. These exemplary embodiments do not constitute all embodiments consistent with the present disclosure. In contrast, they are only examples of devices and methods that are consistent with some aspects of the present disclosure.

Consistent with embodiments of the present disclosure, a terminal may communicate with at least two router apparatuses, and may further interact with a server through a communication link between either one of the router apparatuses and the server. In the present disclosure, a router apparatus refers to an apparatus that has a routing-transfer function, such as a router, a cellphone that is set as a hotspot, or the like.

FIG. 1 is a diagram illustrating a system 100 according to an exemplary embodiment. As shown in FIG. 1, the system 100 includes a terminal 1, a first router apparatus 2, a second router apparatus 3, and a server 4. Although FIG. 1 shows two router apparatuses, embodiments consistent with the present disclosure can include greater or fewer router apparatuses.

As shown in FIG. 1, the terminal 1 is wirelessly connected to the first router apparatus 2 and the second router apparatus 3, respectively. The first router apparatus 2 and the second router apparatus 3 are connected to the server 4. The first router apparatus 2 is wirelessly connected to the server 4 via a first communication link. The second router apparatus 3 is connected to the server 4 via a second communication link, which may be, for example, an optical fiber or a broadband connection. The terminal 1 interacts with the server 4 through the first communication link or the second communication link.

In some embodiments, the first router apparatus 2 includes a portable router, and the second router apparatus 3 includes a wireless router of a different type, such as an ordinary, non-portable wireless router. The first router apparatus 2 has a built-in communication card, such as a SIM card. The first communication link between the first router apparatus 2 and the server 4 is established via the SIM card. In some scenarios, the communication through the first communication link is more expensive than that through the second communication link.

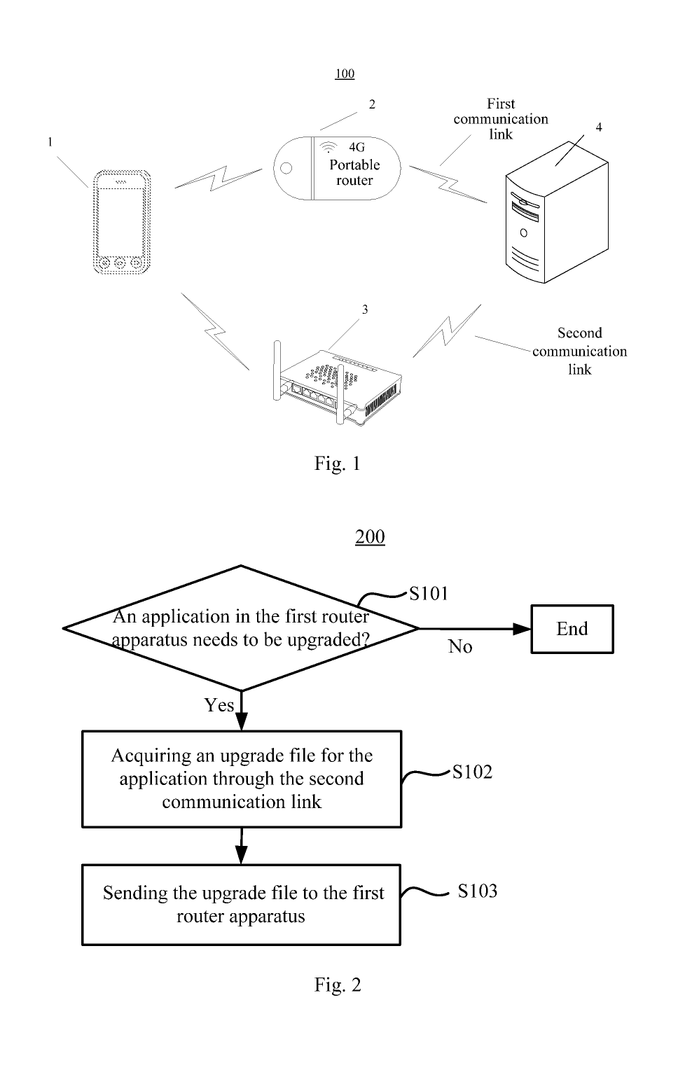

FIG. 2 is a flowchart showing a method 200 for upgrading the first router apparatus 2 according to an exemplary embodiment. The method 200 may be implemented in the terminal 1.

As shown in FIG. 2, at S101, whether an application in the first router apparatus 2 needs to be upgraded is detected. The application may be software in the first router apparatus 2 or an operation system of the first router apparatus 2. In some embodiments, whether the application in the first router apparatus 2 needs to be upgraded is detected when the terminal 1 is communicating with the first router apparatus 2. If the application does not need to be upgraded, the process ends.

On the other hand, if the application in the first router apparatus 2 needs to be upgraded, then at S102, an upgrade file for the application is acquired through the second communication link between the second router apparatus 3 and the server 4.

In some embodiments, the terminal 1 may initiatively access the server 4 through the first communication link or the second communication link. When it is determined that the application in the first router apparatus 2 needs to be upgraded, the upgrade file for upgrading a current version of the application to an upgraded version is requested from the server 4. In some embodiments, the server 4 may initiatively push an upgrade message to the terminal 1. According to the upgrade message, the terminal 1 requests from the server 4 the upgrade file for upgrading the current version of the application to the upgraded version.

At S103, the upgrade file is sent to the first router apparatus 2. The upgrade file can be sent when it is detected that the terminal 1 is connected to the first router apparatus 2. The first router apparatus 2 receives the upgrade file, and upgrades the current version of the application to the upgraded version using the upgrade file.

According to the present disclosure, the upgrade file is acquired through the second communication link, which is less expensive. Further, the communication between the terminal 1 and the first router apparatus 2 is conducted on an internal network. Therefore, no data usage through the communication card in the first router apparatus 2 occurs during the upgrade process, and thus the data usage can be saved for other purposes when needed.

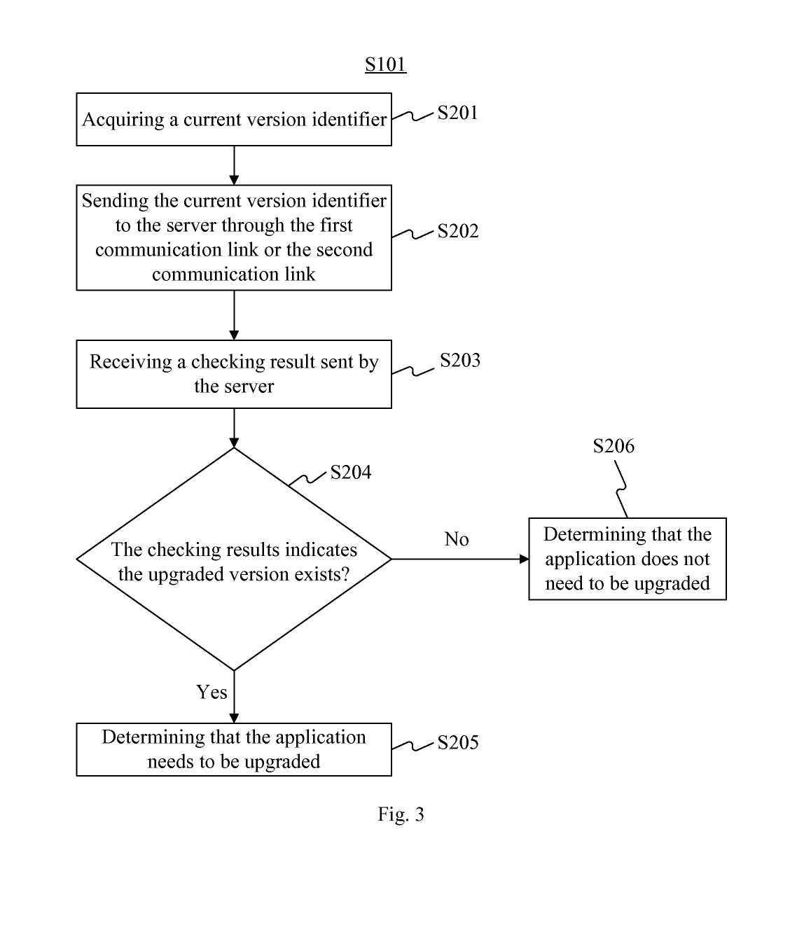

FIG. 3 is a flowchart showing details of an example of S101 in FIG. 2. As shown in FIG. 3, at S201, a current version identifier of the application is acquired. The current version identifier includes at least a current version number and/or a current version generation time. In some embodiments, the terminal 1 may acquire the current version identifier of the application from the first router apparatus 2.

At S202, the current version identifier is sent to the server 4 through the first communication link or the second communication link. In some embodiments, the terminal 1 generates a version detection request for the application, and sends the version detection request to the server 4 through the first communication link or the second communication link. The server 4 receives the version detection request, extracts the current version identifier from the version detection request, acquires a version identifier of the latest version of the locally stored application as a version identifier of the upgraded version of the application, and compares the version identifier of the updated version with the current version identifier.

For example, the server 4 compares a version number of the upgraded version with the current version number, or compares a version generation time of the upgraded version with the current version generation time. If the version number of the upgraded version is greater than the current version number, or if the version generation time of the upgraded version is later than the current version generation time, it is determined that the application needs to be upgraded. A checking result is generated and returned to the terminal 1, which indicates that the upgraded version of the application exists.

On the other hand, if the version number of the upgraded version is less than or equal to the current version number, or if the version generation time of the upgraded version is earlier than or the same as the current version generation time, it is determined that the application does not need to be upgraded. A checking result is generated and returned to the terminal 1, which indicates that the upgraded version does not exist.

For example, version numbers are used as the version identifiers. Assume the current version number is V1.1 and the version number of the upgraded version is V1.4. In this scenario, the version number of the upgraded version is greater than the current version number, and thus the server 4 generates the checking result that indicates the upgraded version exists.

As another example, version generation times are used as the version identifiers. Assume the current version generation time is 20130303 and the version generation time of upgraded version is 20130910. In this scenario, the current version generation time is earlier than the version generation time of the upgraded version, and thus the server 4 generates the checking result that indicates the upgraded version exists.

In some embodiments, the terminal 1 is interacting with the server 4 through the first communication link, and may send the version detection request to the server 4 through the first communication link, to determine whether the application needs to be upgraded. Then, whether the terminal 1 can interact with the server 4 through the second communication link is detected. If the terminal 1 can interact with the server 4 through the second communication link, the terminal 1 directly acquires the upgrade file through the second communication link.

In some embodiments, the terminal 1 first acquires the identifier of the application from the first router apparatus 2, and then detects whether the terminal 1 can interact with the server 4 through the second communication link. If the terminal 1 can interact with the server 4 through the second communication link, the terminal 1 sends the version detection request to the server 4 through the second communication link, to determine whether the application needs to be upgraded. If the application needs to be upgraded, the terminal 1 directly acquires the upgrade file through the second communication link.

At S203, the checking result is received. The checking result is sent by the server after checking whether the upgraded version exists according to the current version identifier.

At S204, whether the checking result indicates that the upgraded version exists is determined.

If the checking result indicates that the upgraded version exists (S204-Yes), then at S205, it is determined that the application needs to be upgraded.

On the other hand, if the checking result indicates that the upgraded version does not exist (S204-No), then at S206, it is determined that the application does not need to be upgraded, and the process ends.

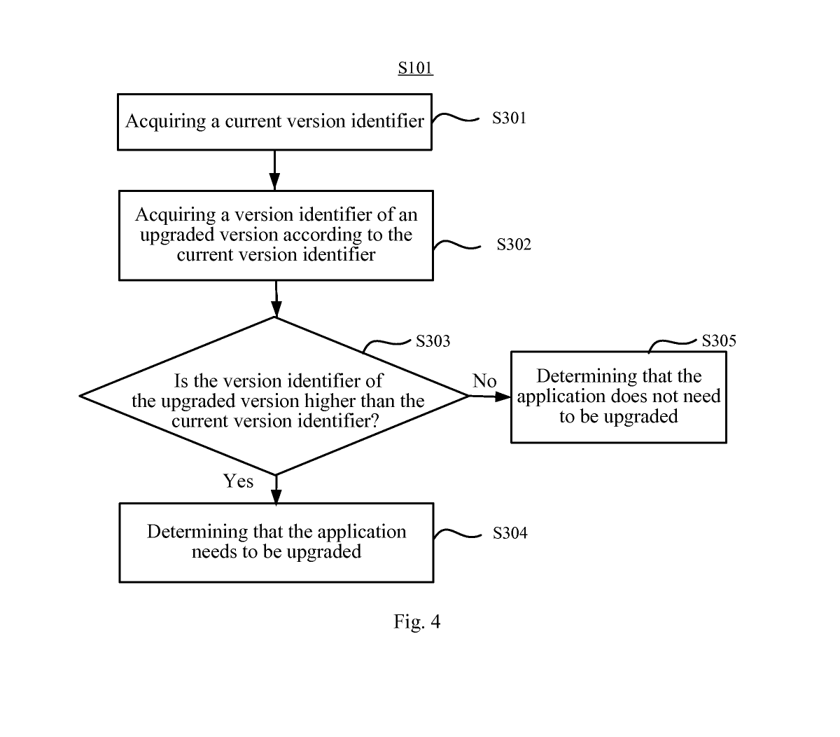

FIG. 4 is a flowchart showing details of another example of S101 in FIG. 2. S301 in FIG. 4 is similar to S201 in FIG. 3, and thus details thereof are omitted.

As shown in FIG. 4, at S302, a version identifier of an upgraded version, to which the application is to be upgraded, is acquired according to the current version identifier. In some embodiments, the terminal 1 generates a version detection request for the application, and sends the version detection request to the server 4 through the first communication link or the second communication link. The server 4 receives the version detection request, acquires a version identifier of the latest version of the locally stored application as a version identifier of the upgraded version of the application, and sends the version identifier of the upgraded version to the terminal 1. The terminal 1 receives the version identifier of the upgraded version sent from the server 4.

At S303, whether the version identifier of the upgraded version is higher than the current version identifier is determined, i.e., whether a version number of the upgraded version is greater than the current version number or whether a version generation time of the upgraded version is later than the current version generation time.

If the version identifier of the upgraded version is higher than the current version identifier, i.e., if the version number of the upgraded version is greater than the current version number or if the version generation time of the upgraded version is later than the current version generation time, then at S304, it is determined that the application needs to be upgraded.

On the other hand, if the version identifier of the upgraded version is lower than or equal the current version identifier, i.e., if the version number of the upgraded version is less than or equal to the current version number or if the version generation time of the upgraded version is earlier than or the same as the current version generation time, then at S305, it is determined that the application does not need to be upgraded, and the process ends.

For example, version numbers are used as the version identifiers. Assume the current version number is V1.1 and the version number of the upgraded version is V1.4. In this scenario, the version number of the upgraded version is greater than the current version number, and thus it is determined that the application needs to be upgraded.

As another example, version generation times are used as the version identifiers. Assume the current version generation time is 20130303 and the version generation time of the upgraded version is 20130910. In this scenario, the current version generation time is earlier than the version generation time of the upgraded version, and thus it is determined that the application needs to be upgraded.

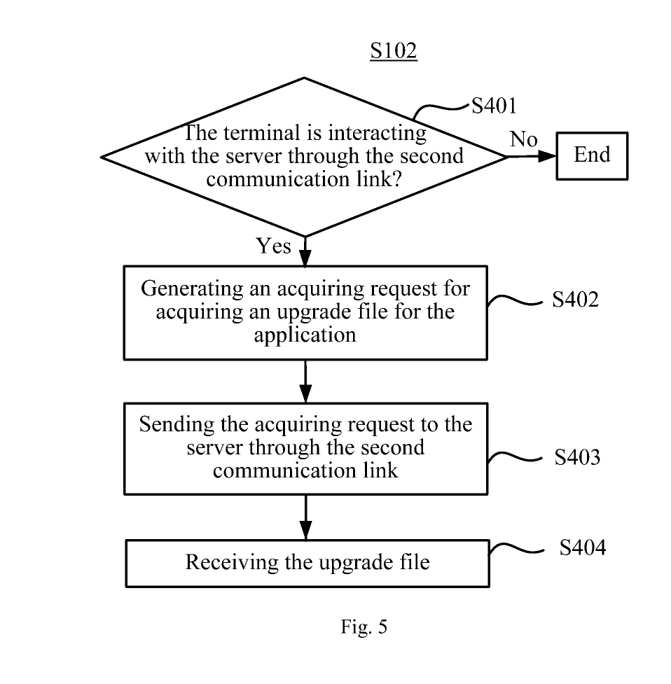

FIG. 5 is a flowchart showing details of an example of S102 in FIG. 2. The method shown in FIG. 5 can be implemented in, e.g., the terminal 1. As shown in FIG. 5, at S401, whether the terminal 1 is interacting with the server 4 through the second communication link is detected.

If the terminal 1 is interacting with the server 4 through the second communication link, then at S402, an acquiring request for acquiring an upgrade file for the application is generated. The upgrade file is configured to upgrade the application from a current version to an upgraded version, and the acquiring request carries a current version identifier of the application.

At S403, the acquiring request is sent to the server 4 through the second communication link. The server 4 receives the acquiring request, extracts the current version identifier from the acquiring request, acquires a version identifier of the upgraded version from a local storage, acquires an upgrade file for upgrading the application from the current version to the upgraded version according to the current version identifier and the version identifier of the upgraded version, and sends the acquired upgrade file to the terminal 1 through the second communication link.

At S404, the upgrade file sent by the server according to the acquiring request is received.

In some embodiments, the method 200 may further include, before sending the upgrade file to the first router apparatus, detecting whether the terminal 1 is interacting with the server 4 through the first communication link and, if so, generating an upgrade reminder according to the upgrade file. Otherwise, the operation ends.

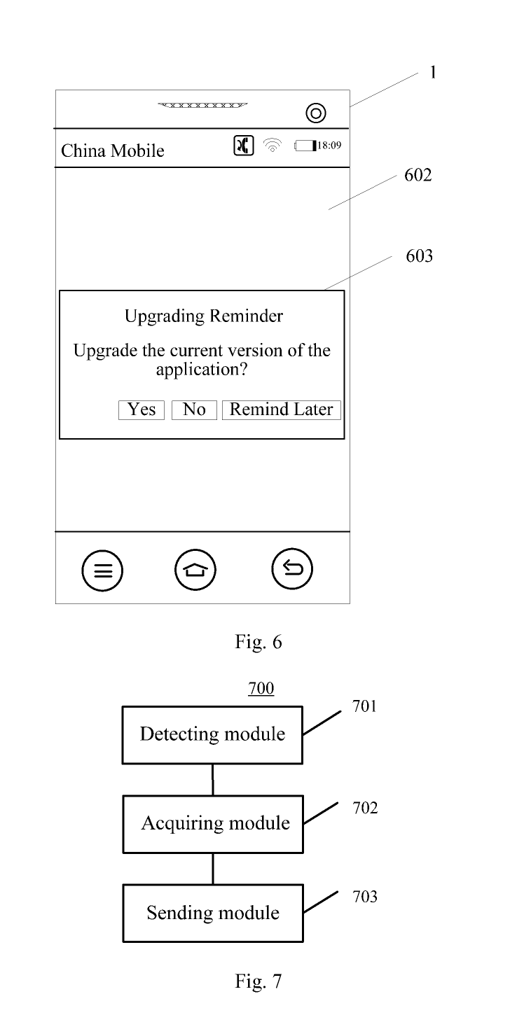

FIG. 6 schematically illustrates an exemplary upgrade reminder. As shown in FIG. 6, the terminal 1 has a display interface 602. The upgrade reminder is presented in the display interface 602 to a user in a pop-up window 603. In some embodiments, as shown in FIG. 6, operation controls such as “Yes”, “No”, and “Remind Later” are also added to the pop-up window 603 for the user to choose. The user can select the “Yes” button in the upgrade reminder illustrated in FIG. 6 to initiate the upgrade operation. With the upgrade reminder, the user can choose when to upgrade. For instance, the user may choose to initiate the upgrade when the usage of memory resource of the terminal 1 is low.

For example, when the operation system of the first router apparatus 2 is being upgraded, generally the first router apparatus 2 will stop working in the process of upgrading the operation system. In this case, the first communication link will be disconnected during the upgrading process and will be reconnected after the upgrading process ends. Thus, if the upgrading is conducted while the terminal 1 is interacting with the server 4 through the first communication link, for example, when the user is browsing a webpage using the terminal 1 through the first communication link, then the user cannot browse the webpage on the terminal 1 through the first communication link anymore, and has to wait until the upgrading is completed. This interrupts the user's browsing of the webpage. Therefore, with the initiating upgrade prompt, the user can choose to upgrade the first router apparatus 2 at an appropriate time, for example, after he/she finishes browsing the webpage.

In some embodiments, the method 200 may further include, before sending the upgrade file to the first router apparatus 2, determining whether an upgrade operation entered according to the upgrade reminder is received and, if so, sending the upgrade file to the first router apparatus 2. Otherwise, the operation ends.

According to the present disclosure, the terminal 1 is connected to the first router apparatus 2 via a local area network similar to, e.g., Bluetooth. Therefore, sending the upgrade file to the first router apparatus 2 by the terminal 1 does not incur any data usage by the communication card in the first router apparatus 2.

In some embodiments, the method 200 may further include, after sending the upgrade file to the first router apparatus 2, determining whether the application is successfully upgraded and, if so, generating and displaying an upgrade success notification. Otherwise, the application is re-upgraded.

In some embodiments, after the application is upgraded, the first router apparatus 2 restarts the application. After the application is successfully restarted, the terminal 1 acquires a version identifier of the restarted application from the first router apparatus 2, determines whether the version identifier of the restarted application is the same as the version identifier of the upgraded version. If they are the same, the terminal 1 determines that the application is successfully upgraded. If they are different, the terminal 1 determines that the application is not successfully upgraded and needs to be re-upgraded.

In some embodiments, if the terminal 1 is a cellphone or a tablet computer that has a display interface, such as a display screen, the upgrade success notification can be displayed in the display interface of the terminal 1 in, for example, a pop-up window. Alternatively, if the terminal 1 is a router or a switch that does not have a display interface, the upgrade success notification can be pushed to a preset terminal such as a tablet computer and displayed in the display interface of the preset terminal.

FIG. 7 is a block diagram showing a device 700 for upgrading according to an exemplary embodiment. The device 700 can be implemented as a terminal that can communicate with at least two router apparatuses, and can interact with a server through a communication link between any one of the router apparatuses and the server.

As shown in FIG. 7, the device 700 includes a detecting module 701, an acquiring module 702, and a sending module 703. The detection module 701 is configured to detect whether an application in a first router apparatus of the at least two router apparatuses needs to be upgraded. The acquiring module 702 is configured to, when the application in the first router apparatus needs to be upgraded, acquire an upgrade file for the application through a communication link between a second router apparatus of the at least two router apparatuses and the server. The sending module 703 is configured to send the upgrade file to the first router apparatus, such that the first router apparatus upgrades the application using the upgrade file.

In some embodiments, the detection module 701 includes a first acquiring unit, a first sending unit, a first receiving unit, and a first determining unit. The first acquiring unit is configured to acquire a current version identifier of the application. The current version identifier includes at least a current version number and/or a current version generation time. The first sending unit is configured to send the current version identifier to the server through the communication link between any one of the router apparatuses and the server. The first receiving unit is configured to receive a checking result sent by the server after checking whether an upgraded version exists according to the current version identifier. The first determining unit is configured to, when the checking result indicates that the upgraded version exists, determine that the application needs to be upgraded, and, when the checking result indicates that the upgraded version does not exist, determine that the application does not need to be upgraded.

In some embodiments, the first detecting module 701 includes the first acquiring unit, a second acquiring unit, a comparing unit, and a second determining unit. The second acquiring unit is configured to acquire a version identifier of the upgraded version of the application according to the current version identifier. The comparing unit is configured to compare the version identifier of the upgraded version with the current version identifier. The second determining unit is configured to, when the version identifier of the upgraded version is higher than the current version identifier, determine that the application needs to be upgraded; and, when the version identifier of the upgraded version is lower than or equal to the current version identifier, determine that the application does not need to be upgraded.

In some embodiments, the second acquiring unit includes a sending subunit and a receiving subunit. The sending subunit is configured to send the current version identifier to the server through the communication link between any one of the router apparatuses and the server. The receiving subunit is configured to receive the version identifier of the upgraded version, sent by the server after checking according to the current version identifier.

In some embodiments, the acquiring module 702 includes a detecting unit, a generating unit, a second sending unit, and a second receiving unit. The detecting unit is configured to detect whether the terminal is interacting with the server through the communication link between the second router apparatus and the server. The generating unit is configured to, when the terminal is interacting with the server, generate an acquiring request for acquiring the upgrade file. The second sending unit is configured to send the acquiring request to the server through the communication link between the second router apparatus and the server. The second receiving unit is configured to receive the upgrade file sent by the server according to the acquiring request.

In some embodiments, the device 700 further includes an additional detecting module, configured to detect whether the terminal is interacting with the server through a communication link between the first router apparatus and the server. In these embodiments, the sending module 703 is further configured to, when the terminal is interacting with the server, send the upgrade file to the first router apparatus.

In some embodiments, the device 700 further includes a first generating module and a first determining module. The first generating module is configured to generate an upgrade reminder according to the upgrade file. The first determining module is configured to determine whether an upgrade operation entered according to the upgrade reminder is received. In these embodiments, the sending module is further configured to, when the upgrade operation is received, send the upgrade file to the first router apparatus.

In some embodiments, the device 700 further includes a second determining module, a second generating module, and a presenting module. The second determining module is configured to determine whether the application is successfully upgraded. The second generating module is configured to, when the application is successfully upgraded, generate an upgrade success notification. The presenting module is configured to present the upgrade success notification.

In some embodiments, the presenting module includes a presenting unit and a pushing unit. The presenting unit is configured to display the upgrade success notification in a local display interface of the terminal. The pushing unit is configured to push the upgrade success notification to a preset terminal, such that the upgrade success notification is displayed on the preset terminal.

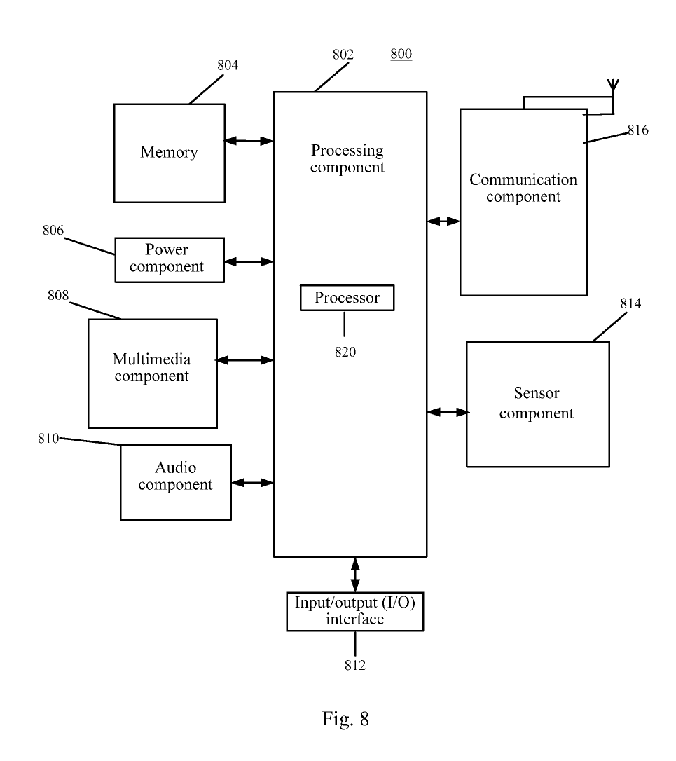

FIG. 8 is a block diagram illustrating a device 800 for upgrading, according to an exemplary embodiment. For example, the device 800 may be a mobile phone, a computer, a digital broadcast terminal, a messaging device, a gaming console, a tablet, a medical device, exercise equipment, a personal digital assistant, or the like.

Referring to FIG. 8, the device 800 includes one or more of the following components: a processing component 802, a memory 804, a power component 806, a multimedia component 808, an audio component 810, an input/output (I/O) interface 812, a sensor component 814, and a communication component 816.

The processing component 802 usually controls overall operations of the device 800, such as operations associated with display, telephone calls, data communications, camera operations and recording operations. The processing component 802 may include one or more processors 820 to execute instructions to perform all or a part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any application or method operated on the device 800, contact data, phonebook data, messages, pictures, videos, etc. The memory 804 may be implemented by any type of volatile or non-volatile memory device or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power to various components of the device 800. The power component 806 may include a power management system, one or more power sources, and other components associated with the generation, management, and distribution of power in the device 800.

The multimedia component 808 includes a screen for providing an output interface between the device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 808 includes a front camera and/or a rear camera. The front camera and/or the rear camera may receive external multimedia data while the device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, a button, or the like. The button may include, but not limited to: a home button, a volume button, a starting button, or a locking button.

The sensor component 814 includes one or more sensors to provide status assessments of various aspects of the device 800. For instance, the sensor component 814 may detect an open/closed status of the device 800, relative position of components, e.g., the display and the keyboard, of the device 800, a change in position of the device 800 or a component of the device 800, a presence or absence of an user contact with the device 800, an orientation or an acceleration/deceleration of the device 800, and a change in temperature of the device 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an accelerometer sensor, a gyroscope sensor, a magnetic sensor, a pressure sensor, or a temperature sensor.

The communication component 816 is configured to facilitate communication, in a wire or wireless manner, between the device 800 and other devices. The device 800 may access a wireless network based on a communication standard, such as WiFi, 2G 3G, or 4G, or a combination thereof In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-bandwidth (UWB) technology, a Bluetooth (BT) technology, and other technologies.

In exemplary embodiments, the device 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, for performing the above described methods.

In exemplary embodiments, there is further provided a non-transitory computer-readable storage medium, such as included in the memory 804, storing instructions executable by the processor 820 in the device 800, for performing methods consistent with embodiments of the present disclosure. For example, the non-transitory computer-readable storage medium may be a ROM, a random access memory (RAM), a CD-ROM, a magnetic tape, a floppy disc, an optical data storage device and the like.

The specific manners for performing operations of a device according to the present disclosure are similar to methods according to the present disclosure, such as those described above.

After considering this description and performing the disclosure herein, those skilled in the art will anticipate other implementation aspects of the present disclosure. The present application is meant to cover any variations, usage or adaptive change of the present disclosure, and these variations, usage or adaptive change follow general concepts of the present disclosure and include the common knowledge or the customary technical means in the technical field that is not disclosed in the present disclosure. The description and embodiments are only exemplary, and the real range and spirit of the present disclosure are defined by the following claims.

It should be understood that the present disclosure is not limited to precise structures that are described above and shown in the accompanying drawings, and may be modified and changed without departing from the range of the present disclosure. The scope of the present disclosure is only defined by the appended claims.

What is claimed is:

1. A method for upgrading a first router apparatus of at least two router apparatuses communicating with a terminal and a server, comprising:
detecting whether an application in the first router apparatus needs to be upgraded;
acquiring, if the application needs to be upgraded, an upgrade file from the server through a communication link between a second router apparatus of the at least two router apparatuses and the server; and
sending the upgrade file to the first router apparatus.

2. The method according to claim 1, wherein detecting whether the application needs to be upgraded includes:
acquiring a current version identifier of the application;
sending the current version identifier to the server through a communication link between the first router apparatus and the server or the communication link between the second router apparatus and the server;
receiving a checking result sent by the server, the checking result indicating whether an upgraded version, to which the application is to be upgraded, exists in a storage of the server; and
determining whether the application needs to be upgraded according to the checking result.

3. The method according to claim 1, wherein detecting whether the application needs to be upgraded includes:
acquiring a current version identifier of the application;
acquiring a version identifier of an upgraded version, to which the application is to be upgraded, from the server;
comparing the version identifier of the upgraded version with the current version identifier; and
determining whether the application needs to be upgraded according to whether the version identifier of the upgraded version is higher than the current version identifier.

4. The method according to claim 3, wherein acquiring the version identifier of the upgraded version includes:
sending the current version identifier to the server through a communication link between the first router apparatus and the server or the communication link between the second router apparatus and the server; and
receiving the version identifier of the upgraded version from the server.

5. The method according to claim 1, wherein acquiring the upgrade file includes:
detecting, by the terminal, whether the terminal interacts with the server through the communication link between the second router apparatus and the server;
generating, if the terminal interacts with the server through the communication link between the second router apparatus and the server, an acquiring request for acquiring the upgrade file;
sending the acquiring request to the server through the communication link between the second router apparatus and the server; and
receiving the upgrade file from the server according to the acquiring request.

6. The method according to claim 1, further comprising:
detecting, by the terminal, whether the terminal interacts with the server through a communication link between the first router apparatus and the server,
wherein sending the upgrade file to the first router apparatus includes sending, when the terminal interacts with the server, the upgrade file to the first router apparatus.

7. The method according to claim 1, further comprising:
generating an upgrading reminder according to the upgrade file; and
determining whether an upgrade operation entered according to the upgrading reminder is received,
wherein sending the upgrade file to the first router apparatus includes sending, when the upgrade operation is received, the upgrade file to the first router apparatus.

8. The method according to claim 1, further comprising:
determining whether the application is successfully upgraded;
generating, if the application is successfully upgraded, an upgrade success notification; and
presenting the upgrade success notification.

9. The method according to claim 8, wherein presenting the upgrade success notification includes:
displaying the upgrade success notification in a local display interface of the terminal; or
pushing, by the terminal, the upgrade success notification to a preset terminal for displaying on the preset terminal.

10. A device for upgrading a first router apparatus of at least two apparatuses communicating with the device and a server, comprising:
a processor; and
a non-transitory computer-readable storage medium storing instructions that, when executed by the processor, cause the processor to:
detect whether an application in the first router apparatus needs to be upgraded;
acquire, if the application needs to be upgraded, an upgrade file from the server through a communication link between a second router apparatus of the at least two router apparatuses and the server; and
send the upgrade file to the first router apparatus.

11. The device according to claim 10, wherein the instructions further cause the processor to:
acquire a current version identifier of the application;
send the current version identifier to the server through a communication link between the first router apparatus and the server or the communication link between the second router apparatus and the server;
receive checking result sent by the server, the checking result indicating whether an upgraded version, to which the application is to be upgraded, exists in a storage of the server; and
determine whether the application needs to be upgraded according to the checking result.

12. The device according to claim 10, wherein the instructions further cause the processor to:
acquire a current version identifier of the application;
acquire a version identifier of an upgraded version, to which the application is to be upgraded, from the server;
compare the version identifier of the upgraded version with the current version identifier; and
determine whether the application needs to be upgraded according to whether the version identifier of the upgraded version is higher than the current version identifier.

13. The device according to claim 12, wherein the instructions further cause the processor to:
send the current version identifier to the server through a communication link between the first router apparatus and the server or the communication link between the second router apparatus and the server; and
receive the version identifier of the upgraded version from the server.

14. The device according to claim 10, wherein the instructions further cause the processor to:
detect whether the device interacts with the server through the communication link between the second router apparatus and the server;
generate, if the device interacts with the server through the communication link between the second router apparatus and the server, an acquiring request for acquiring the upgrade file;
send the acquiring request to the server through the communication link between the second router apparatus and the server; and
receive the upgrade file sent by the server according to the acquiring request.

15. The device according to claim 10, wherein the instructions further cause the processor to:
detect whether the device interacts with the server through a communication link between the first router apparatus and the server; and
send, when the device interacts with the server, the upgrade file to the first router apparatus.

16. The device according to claim 10, wherein the instructions further cause the processor to:
generate an upgrading reminder according to the upgrade file;
determine whether an upgrade operation entered according to the upgrading reminder is received; and
send, when the upgrade operation is received, the upgrade file to the first router apparatus.

17. The device according to claim 10, wherein the instructions further cause the processor to:
determine whether the application is successfully upgraded;
generate, if the application is successfully upgraded, an upgrade success notification; and
present the upgrade success notification.

18. The device according to claim 17, wherein the instructions further cause the processor to:
display the upgrade success notification in a local display interface of the device; or
push the upgrade success notification to a preset terminal for displaying on the preset terminal.

19. A non-transitory computer-readable storage medium storing instructions for upgrading a first router apparatus of at least two router apparatuses communicating with a terminal and a server, the instructions, when executed by one or more processors of the terminal, causing the terminal to:
detect whether an application in the first router apparatus needs to be upgraded;
acquire, if the application needs to be upgraded, an upgrade file from the server through a communication link between a second router apparatus of the at least two router apparatuses and the server; and
send the upgrade file to the first router apparatus.
